(19) United States
(12) Patent Application Publication
(10) Pub. No.: US 2012/0265649 A1
(43) Pub. Date: Oct. 18, 2012

(54) Method, System and Program Product for Transactions

(76) Inventor: Sandeep Kambo, San Diego, CA (US)

(21) Appl. No.: 13/446,868

(22) Filed: Apr. 13, 2012

Related U.S. Application Data
(60) Provisional application No. 61/475,420, filed on Apr. 14, 2011.

(51) Int. Cl. G06Q 30/06

(52) U.S. Cl. 705/27.1

(57) ABSTRACT

A method, system and program product comprise communicating a seller's registration information and the seller's item information to a transaction unit. The transaction unit registers an account for the seller comprising a dashboard. The seller's item information comprises a description of the item without a price. A buyer's registration information and the buyer's offer for the seller's item are communicated to the transaction unit. The transaction unit registers an account for the buyer comprising a dashboard. The buyer's offer comprises an offer price and a description of an expected item to be delivered. The transaction unit posts the buyer's offer to the seller's dashboard and notifies the seller. The seller's response for the buyer's offer comprises an acceptable price and a description of the item to be provided at the acceptable price. The transaction unit posts the seller's response to the buyer's dashboard and notifies the buyer.

### CROSS-REFERENCE TO RELATED APPLICATIONS

The present Utility patent application claims priority benefit of the U.S. provisional application for patent Ser. No. 61/475,420 filed on 14 Apr. 2011 under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to communication systems. More particularly, one or more embodiments of the invention relate to systems for performing transactions.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Conventional retail business is typically performed by providers of products and services presenting the products/services for sale at associated prices with buyers selecting from the presented products/services with associated prices.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram an example transaction system, in accordance with an embodiment of the present invention;

FIG. 2 is an example presentation to seller as described with reference to FIG. 1, in accordance with an embodiment of the present invention;

FIGS. 3A-C illustrates an example method for the transaction system as described with reference to FIGS. 1-2, in accordance with an embodiment of the present invention;

FIG. 4 illustrates a block diagram depicting a conventional client/server communication system; and

FIG. 5 illustrates a typical computer system that, when appropriately configured or designed, may serve as a computer system for which the present invention may be embodied.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

A transaction system will be described which provides means and methods for performing exchanges of products and services between buyers and sellers. Products and services are provided by sellers in exchange for financial compensation from buyers. Sellers provide information associated with products and services to transaction system. Non-limiting examples of information provided by sellers include product/service category or categories. Buyers browse/search transaction system for products and services. Buyers select to purchase products and services and provide information associated with purchase. As a non-limiting example, buyer provides price information associated with purchase. System processes information provided by buyer and notifies sellers of details provided by buyer. Sellers may accept to provide product/service or may select to provide a counter offer. Buyers may select offers of sellers or counter offers of sellers followed by performing a transaction for an exchange of products/services with financial compensation.

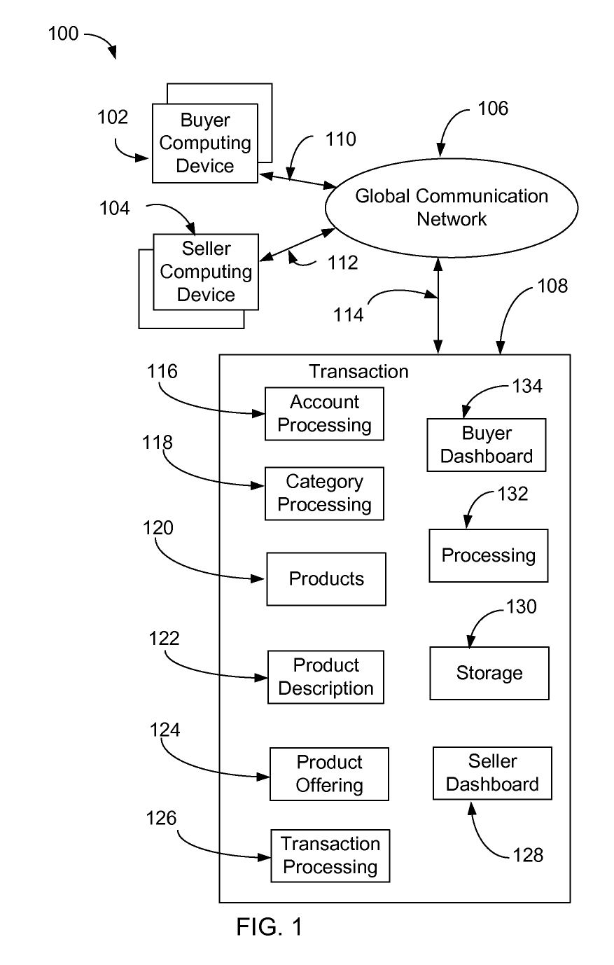

The system will now be described in detail with reference to FIGS. 1-5.

FIG. 1 is a block diagram an example transaction system, in accordance with an embodiment of the present invention.

A transaction system 100 includes multiplicity of buyer computing devices with a sampling noted as a buyer computing device 102, a multiplicity of seller computing devices with a sampling noted as a seller computing device 104, a global communication network 106, and an transaction portion 108.

Global communication network 106 communicates bi-directionally with buyer computing device 102 via a communication channel 110, with seller computing device 104 via a communication channel 112 and with transaction portion 108 via a communication channel 114.

Buyer computing device 102 transmits, receives, stores, retrieves, processes and presents information associated with a buyer (not shown). Seller computing device 104 transmits, receives, stores, retrieves, processes and presents information associated with a seller (not shown). Global communication network receives, transmits and processes information for communicating with a multiplicity of devices. Non-limiting examples for communication via global communication network include wired, wireless and local area network. Transaction portion 108 receives, transmits, stores, retrieves and processes information for performing transactions.

Transaction portion 108 includes an account processing portion 116, a category processing portion 118, a products portion 120, a product description portion 122, a product offering portion 124, a transaction processing portion 126, a seller dashboard portion 128, a storage portion 130, a processing portion 132 and a buyer dashboard portion 134.

Account processing portion 116 performs account processing associated with buyer and seller. Category processing performs category processing associated with categories of products and services. Products portion 120 performs processing associated with products and services. Product requirements portion 122 performs processing associated with product requirements. Product offering portion 124 performs processing associated with product offering. Transaction processing portion 126 performs transaction processing associated with financial exchanges for products and services. Seller dashboard portion 128 processes and provides information associated with available product and service offerings. Storage portion 130 receives, stores and retrieves information. Processing portion 132 receives, processes and transmits information associated with transaction portion 108. Buyer dashboard portion 134 provides information to buyer associated with product offerings and counter offers provided by sellers.

In operation, buyer via buyer computing device 102 and seller via seller computing device 104 create accounts via account processing portion 116. Seller posts products and services to category processing portion 118 where products and services are categorized and associated with products portion 120. Buyer browses or searches products portion 120 for products and services to purchase. Buyer posts request information to purchase products and services associated with products portion 120 with the product and service requirements associated with the product request being processed via product description portion 122. Non-limiting examples of request information include price, quantity and date of deliver. Product description portion 122 receives product and service requirements and notifies respective sellers of products and services which buyers are interested in purchasing. Sellers post product and service offering information to product offering portion 124. Non-limiting examples of product and service offering information include price and estimated delivery date. Sellers may also create a new menu of products and services with associated information. Non-limiting examples of associated information include price. Buyers view and select to purchase product and service offerings associated with product offering portion 124 and seller dashboard portion 128. Products and services purchased by buyer and sold by seller are processed by transaction processing portion 126.

As non-limiting examples, transaction system 100 may be used for business-to-business, business-to-consumer, consumer-to-business and consumer-to-consumer. Businesses and/or service providers may create an account with transaction system 100 and advertise their products and services for sale. Buyers (e.g. consumers) may access the system and search for products and services to purchases. Furthermore, buyers may post information associated with products and services they are seeing to purchase. Non-limiting examples for posted information include price, quantity and date of delivery. As a non-limiting example, sellers may post information associated with a meals for sale. Non-limiting examples for categories of information posted include vegetarian, non-vegetarian, seafood and vegan. Non-limiting examples for information types posted of restaurants include casual dining, fine dining, fast food and catering. As a non-limiting example, buyers access transaction system 100 and enter information associated with products and services for restaurants. Non-limiting examples for information entered include category, type, cuisine, number of diners, date, time and geographic location. Non-limiting examples for geographic information include postal zip code. Received information is processed and analyzed associated with restaurants, respective categories and other provided information. Associated restaurants access the sy0stem and their respective dashboard and respond by selecting products previously posted via the system as a response. Buyer receives notification of seller responses. Non-limiting methods for response notification include Short Message Service (SMS), telephone call and email. Buyer selects from seller responses for purchasing a product.

As a non-limiting example, system may be used by flower shops where flower shops post arrangements and buyers may select a category, a type of arrangement and price. Furthermore, flower shops are notified of buyer's selections and are presented with opportunity to accept the buyer's selections. Furthermore, flower shops may agree to buyer's selections and perform a transaction.

As a non-limiting example, hotels may use the system for posting their product offering information. Non-limiting examples of information posted include quality of facility, location and amenities. The buyer may access the system and select the type of hotel sought and an associated price. Hotels may then notified of the buyer's selections and agree to proceed with the transaction.

As a non-limiting example, sellers do not set a price and users bid on broad categories (e.g., “a three course dinner”). As a result of sellers not setting an initial price, sellers can configure a unique product offering that is equal to or under the buyer's bid price. Furthermore, seller product offering may have proprietary or value-added elements enabling the seller to win favor and the purchase from the buyer. Transaction system gives vendors incentive to creatively provide suitable products providing advantages to the consumer, while at the same time giving sellers the chance to leverage their value-added capabilities for making a sale.

FIG. 1 is a block diagram an example transaction system where buyers and sellers may interact for making a transaction.

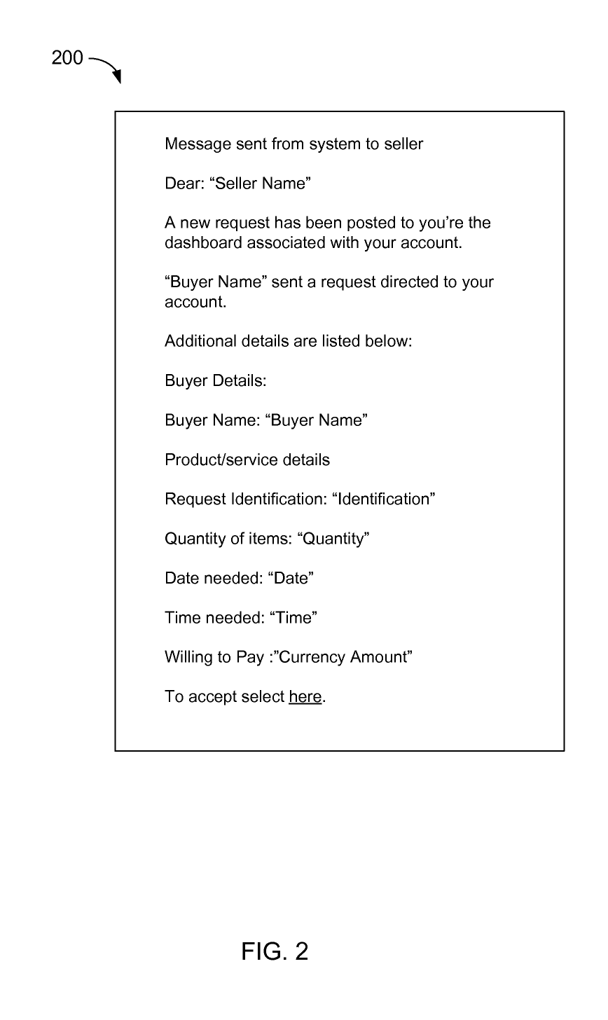

Operation of the transaction system presented in FIG. 1 is further described with reference to FIG. 2 below.

FIG. 2 is an example presentation to seller as described with reference to FIG. 1, in accordance with an embodiment of the present invention.

A presentation 200 provides information to a seller or sellers related to a purchase selection preformed by a buyer.

Non-limiting examples of information presented via presentation 200 include title of message, seller name, nature of presentation, buyer name, product/services details, identifier information, quantity of products/services, date needed, time needed and amount willing to pay.

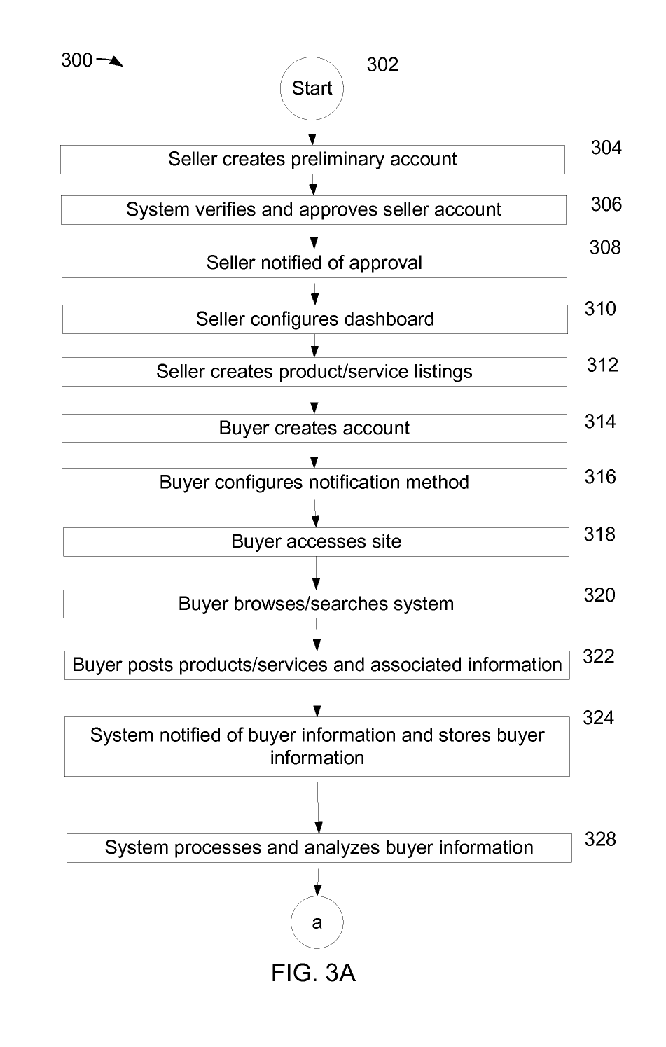

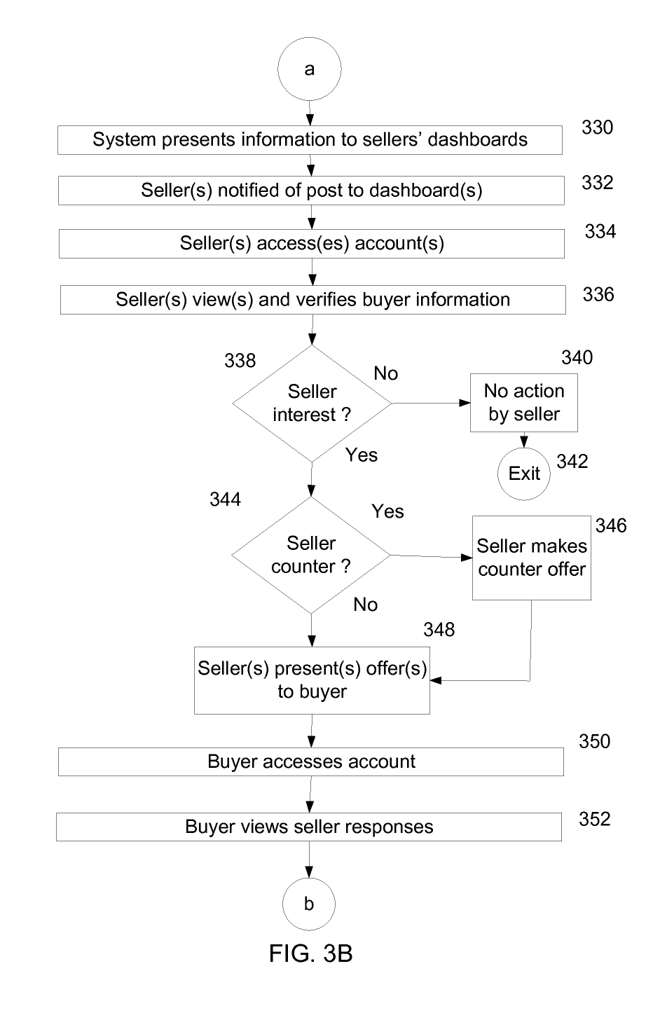

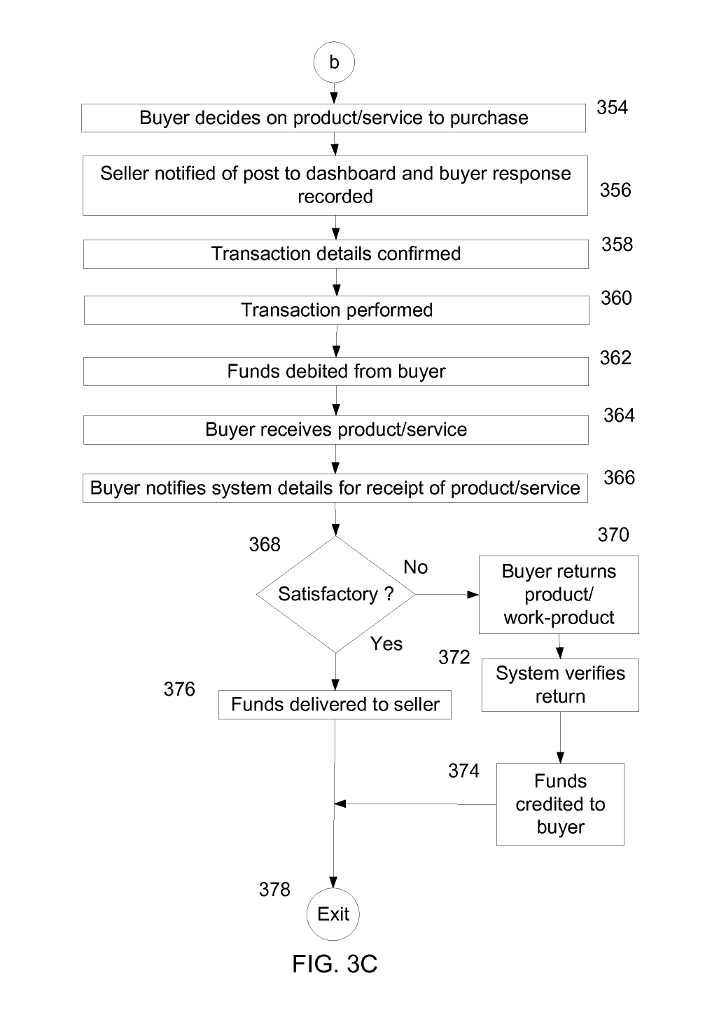

FIG. 2 is an example presentation to seller as described with reference to FIG. 1 where information associated with a buyer's product/service selection is presented. A method of performing the operation of the transaction system as described with reference to FIGS. 1-2 will now be described with reference to FIG. 3.

FIGS. 3A-C illustrates an example method for the transaction system as described with reference to FIGS. 1-2, in accordance with an embodiment of the present invention.

Referring to FIG. 3A, a method 300 initiates in a step 302.

Then in a step 304, seller creates preliminary account.

As a non-limiting example, seller enters information needed for creating an account with provided information processed by account processing portion 116. Non-limiting examples of information provided include name, address, phone number email address, credit card number and password.

Referring back to FIG. 3A, then in a step 306 system verifies and approves seller account.

As a non-limiting example, account processing portion 116 (FIG. 1) verifies information provided by seller and approves account. Non-limiting examples of information verified include name, address, phone number and credit card information. Furthermore, administer (not shown) associated with management of transaction portion 108 may also verify and approve account.

Referring back to FIG. 3A, then in a step 308 seller is notified of approval.

As a non-limiting example, account processing portion 116 (FIG. 1) notifies seller of account approval. Furthermore, seller may be provided an approval code associated with approval.

Referring back to FIG. 3A, then in a step 310 seller configures dashboard.

As a non-limiting example, seller via seller computing device 104 (FIG. 1) configures dashboard via seller dashboard portion 128 (FIG. 1). As a non-limiting example, seller may configure communication settings. Furthermore, as non-limiting examples, seller may configure dashboard for being notified by email, SMS and/or chat.

Referring back to FIG. 3A, then in a step 312 seller creates product/service listings.

As a non-limiting example, seller, via seller computing device 104 (FIG. 1), creates product/service listings associated with products portion 120 (FIG. 1). Non-limiting examples of information associated with listings include products, type, category, specialty and pictures.

Referring back to FIG. 3A, then in a step 314 buyer creates account.

As a non-limiting example, buyer interfacing with buyer computing device 102 (FIG. 1), creates an account via account processing portion 116 (FIG. 1). Non-limiting examples of information provided by buyer include name, address, phone number, email address, notification selections and password. Step 314 may be performed at this point in the execution of method 300 or later as needed by the buyer.

Referring back to FIG. 3A, then in a step 316 buyer configures notification method.

As a non-limiting example, buyer configures notification selection via account processing portion 116 (FIG. 1). Non-limiting examples for notification selection include email and SMS.

Referring back to FIG. 3A, then in a step 318 buyer accesses site.

As a non-limiting example, buyer assess site via account processing portion 116. Buyer may access site following creation of account or prior to creating an account.

Referring back to FIG. 3A, then in a step 320 buyer browses/searches system.

As a non-limiting example, buyer browses or searches for products and services associated with products portion 120 (FIG. 1).

Referring back to FIG. 3A, then in a step 322 buyer posts product/services and associated information.

As a non-limiting example, buyer posts information associated with products and services interested in purchasing to product description portion 122 (FIG. 1). Non-limiting examples of information provided include city, state, country, quantity of items, date needed, business type, business specialty service, business category, zip code, allowed distance from zip code and price willing to pay. Furthermore, buyer may select the “SEND” selection in order to post the information to product description portion 122 (FIG. 1).

Referring back to FIG. 3A, then in a step 324 system is notified of buyer information and stores buyer information.

As a non-limiting example, processing portion 132 (FIG. 1) is notified of information provided by buyer with information provided by buyer being posted to storage portion 130 (FIG. 1).

Referring back to FIG. 3A, then in a step 328 system processes and analyzes buyer information.

As a non-limiting example, processing portion 132 (FIG. 1) processes information received from buyer. Non-limiting examples of processing performed include business categorization and sorting.

Referring to FIG. 3B, then in a step 330 system presents information to sellers' dashboards.

As a non-limiting example, processing portion presents processed buyer information to seller dashboard portion 128 (FIG. 1).

Referring back to FIG. 3B, then in a step 332 sellers notified of posts to dashboards.

As a non-limiting example, seller is notified of information posted to dashboard via seller dashboard portion 128 (FIG. 1). Non-limiting examples for performing notification include email and SMS.

Referring back to FIG. 3B, then in a step 334 sellers access respective accounts.

Sellers access respective accounts via account processing portion 116 (FIG. 1).

Referring back to FIG. 3B, then in a step 336 sellers view and verify buyer information.

As a non-limiting example, sellers access dashboard information posted to seller dashboard portion 128 (FIG. 1). A non-limiting example of information posted to dashboard is presented via presentation 200 (FIG. 2).

Referring back to FIG. 3B, then in a step 338 a determination for seller interest is performed.

Referring back to FIG. 3B, for a determination in step 338 of no seller interested, then in a step 340 seller does not respond followed by termination of execution for method 300 in a step 342.

Referring back to FIG. 3B, for a determination in step 338 of seller interest, then in a step 344 a determination for seller counter offer is performed.

Referring back to FIG. 3B, for a determination of seller counter offer in step 344, then in a step 346 seller makes a counter offer.

As a non-limiting example, seller presents counter offer to buyer via product offering portion 124 (FIG. 1).

Referring back to FIG. 3B, for a determination of no seller counter offer in step 344, then in a step 348 sellers present offers to buyer.

As a non-limiting example, seller presents offer to buyer via product offering portion 124 (FIG. 1).

Referring back to FIG. 3B, then in a step 350 buyer accesses account.

As a non-limiting example, buyer accesses account via account processing portion 116 (FIG. 1).

Referring back to FIG. 3B, then in a step 352 buyer views seller responses.

As a non-limiting example, buyer views responses of sellers via buyer dashboard portion 134 (FIG. 1).

Referring to FIG. 3C, then in a step 354 buyer makes decision with respect to purchasing product/service.

As a non-limiting example, buyer decides on a product and/or service to purchase after viewing available choices.

Referring back to FIG. 3C, then in a step 356 seller is notified of post to dashboard related to potential purchase.

As a non-limiting example, seller associated with selected product/service is notified of selection via seller dashboard portion 128 (FIG. 1). Furthermore, information associated with selection is stored via storage portion 130 (FIG. 1).

Referring to FIG. 3C, then in a step 358 transaction details confirmed.

As a non-limiting example, transaction details confirmed. Furthermore, buyer provides information associated with seller. Furthermore, arrangement for payment is performed. Furthermore, details associated with pickup and deliver are performed.

Referring to FIG. 3C, then in a step 360 transaction is performed.

As a non-limiting example, buyer performs payment transaction via transaction processing portion 126 (FIG. 1). Furthermore, confirmation notification associated with payment processing is transmitted to seller.

Referring to FIG. 3C, then in a step 362 funds debited from buyer.

As a non-limiting example, funds are debited from buyer via transaction processing portion 126 (FIG. 1).

Referring to FIG. 3C, then in a step 364 buyer receives product/service.

Product/service is delivered to buyer. Non-limiting examples of deliver include email and postal.

Referring to FIG. 3C, then in a step 366 buyer notifies system of the details associated with receipt of product/service.

As a non-limiting example, buyer notifies transaction processing portion 126 (FIG. 1) of receipt of product/service.

Referring to FIG. 3C, then in a step 368 a determination for buyer satisfaction is performed.

Referring to FIG. 3C, for a determination on buyer not satisfied in step 368, then in a step 370 buyer returns product/work-product.

As a non-limiting example, buyer returns product/work-product to seller and notifies transaction processing portion 126 (FIG. 1).

Referring to FIG. 3C, then in a step 372 system verifies returned product/work-product.

As a non-limiting example, transaction processing portion 126 (FIG. 1) verifies returned product/work-product with seller.

Referring to FIG. 3C, then in a step 374 funds are credited to buyer.

As a non-limiting example, funds are credited to buyer via transaction processing portion 126 (FIG. 1).

Referring to FIG. 3C, for a determination in step 368 of buyer satisfied in step 368, then in a step 376 funds are delivered to seller.

As a non-limiting example, funds are credited to seller via transaction processing portion 126 (FIG. 1).

Referring to FIG. 3C, then in a step 378 execution of method 300 terminates.

FIGS. 3A-C illustrates an example method for the transaction system as described with reference to FIGS. 1-2 where buyers and sellers perform transactions for exchanging products/services.

A transaction system has been described which provides means and methods for performing exchanges of products and services between buyers and sellers. Products and services are provided by sellers in exchanges for financial compensation from buyers. Sellers provide information associated with products and services to transaction system. Non-limiting examples of information provided by sellers include product/service category or categories. Buyers browse/search transaction system for products and services. Buyers select to purchase products and services and provide information associated with purchase. As a non-limiting example, buyer provides price information associated with purchase. System processes information provided by buyer and notifies sellers of details provided by buyer. Sellers may accept to provide product/service or may select to provide a counter offer. Buyers may select offers of sellers or counter offers of sellers followed by performing a transaction for an exchange of products/services with financial compensation.

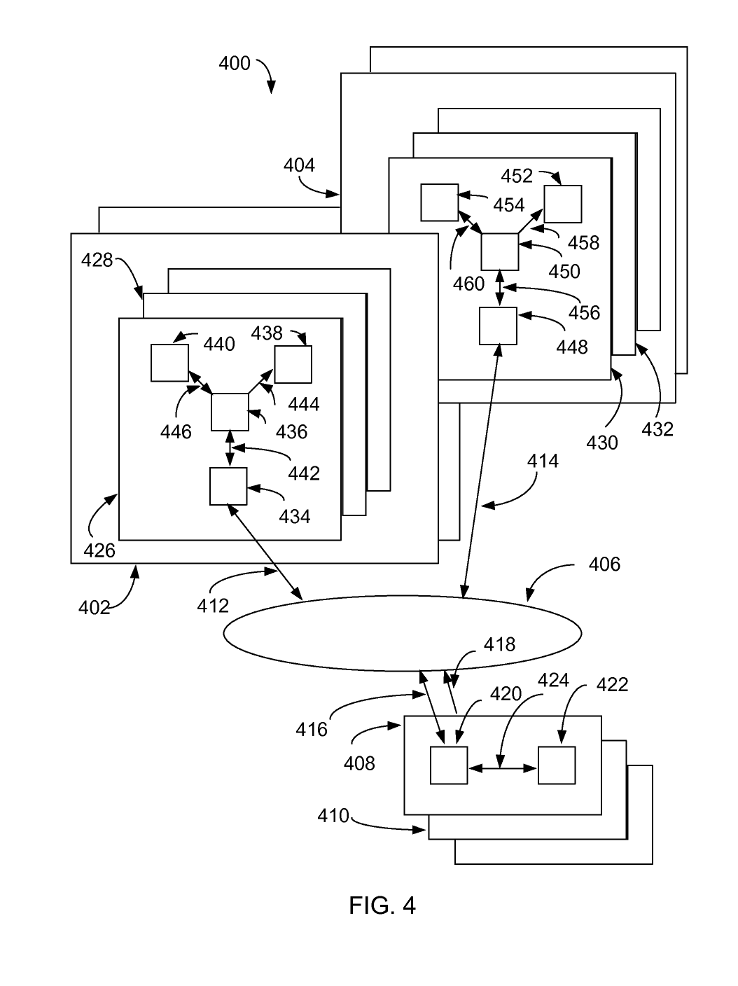

FIG. 4 illustrates a block diagram depicting a conventional client/server communication system.

A communication system 400 includes a multiplicity of networked regions with a sampling of regions denoted as a network region 402 and a network region 404, a global network 406 and a multiplicity of servers with a sampling of servers denoted as a server device 408 and a server device 410.

Network region 402 and network region 404 may operate to represent a network contained within a geographical area or region. Non-limiting examples of representations for the geographical areas for the networked regions may include postal zip codes, telephone area codes, states, counties, cities and countries. Elements within network region 402 and 404 may operate to communicate with external elements within other networked regions or within elements contained within the same network region.

In some implementations, global network 406 may operate as the Internet. It will be understood by those skilled in the art that communication system 400 may take many different forms. Non-limiting examples of forms for communication system 400 include local area networks (LANs), wide area networks (WANs), wired telephone networks, cellular telephone networks or any other network supporting data communication between respective entities via hardwired or wireless communication networks. Global network 406 may operate to transfer information between the various networked elements.

Server device 408 and server device 410 may operate to execute software instructions, store information, support database operations and communicate with other networked elements. Non-limiting examples of software and scripting languages which may be executed on server device 408 and server device 410 include C, C++, C# and Java.

Network region 402 may operate to communicate bi-directionally with global network 406 via a communication channel 412. Network region 404 may operate to communicate bi-directionally with global network 406 via a communication channel 414. Server device 408 may operate to communicate bi-directionally with global network 406 via a communication channel 416. Server device 410 may operate to communicate bi-directionally with global network 406 via a communication channel 418. Network region 402 and 404, global network 406 and server devices 408 and 410 may operate to communicate bi-directionally and also communicate bi-directionally with other networked device located within communication system 400.

Server device 408 includes a networking device 420 and a server 422. Networking device 420 may operate to communicate bi-directionally with global network 406 via communication channel 416 and with server 422 via a communication channel 424. Server 422 may operate to execute software instructions and store information.

Network region 402 includes a multiplicity of clients with a sampling denoted as a client 426 and a client 428. Client 426 includes a networking device 434, a processor 436, a GUI 438 and an interface device 440. Non-limiting examples of devices for GUI 438 include monitors, televisions, cellular telephones, smartphones and PDAs (Personal Digital Assistants). Non-limiting examples of interface device 440 include pointing device, mouse, trackball, scanner and printer. Networking device 434 may communicate bi-directionally with global network 406 via communication channel 412 and with processor 436 via a communication channel 442. GUI 438 may receive information from processor 436 via a communication channel 444 for presentation to a user for viewing. Interface device 440 may operate to send control information to processor 436 and to receive information from processor 436 via a communication channel 446. Network region 404 includes a multiplicity of clients with a sampling denoted as a client 430 and a client 432. Client 430 includes a networking device 448, a processor 450, a GUI 452 and an interface device 454. Non-limiting examples of devices for GUI 438 include monitors, televisions, cellular telephones, smartphones and PDAs (Personal Digital Assistants). Non-limiting examples of interface device 440 include pointing devices, mousse, trackballs, scanners and printers. Networking device 448 may communicate bi-directionally with global network 406 via communication channel 414 and with processor 450 via a communication channel 456. GUI 452 may receive information from processor 450 via a communication channel 458 for presentation to a user for viewing. Interface device 454 may operate to send control information to processor 450 and to receive information from processor 450 via a communication channel 460.

For example, consider the case where a user interfacing with client 426 may want to execute a networked application. A user may enter the IP (Internet Protocol) address for the networked application using interface device 440. The IP address information may be communicated to processor 436 via communication channel 446. Processor 436 may then communicate the IP address information to networking device 434 via communication channel 442. Networking device 434 may then communicate the IP address information to global network 406 via communication channel 412. Global network 406 may then communicate the IP address information to networking device 420 of server device 408 via communication channel 416. Networking device 420 may then communicate the IP address information to server 422 via communication channel 424. Server 422 may receive the IP address information and after processing the IP address information may communicate return information to networking device 420 via communication channel 424. Networking device 420 may communicate the return information to global network 406 via communication channel 416. Global network 406 may communicate the return information to networking device 434 via communication channel 412. Networking device 434 may communicate the return information to processor 436 via communication channel 442. Processor 436 may communicate the return information to GUI 438 via communication channel 444. User may then view the return information on GUI 438.

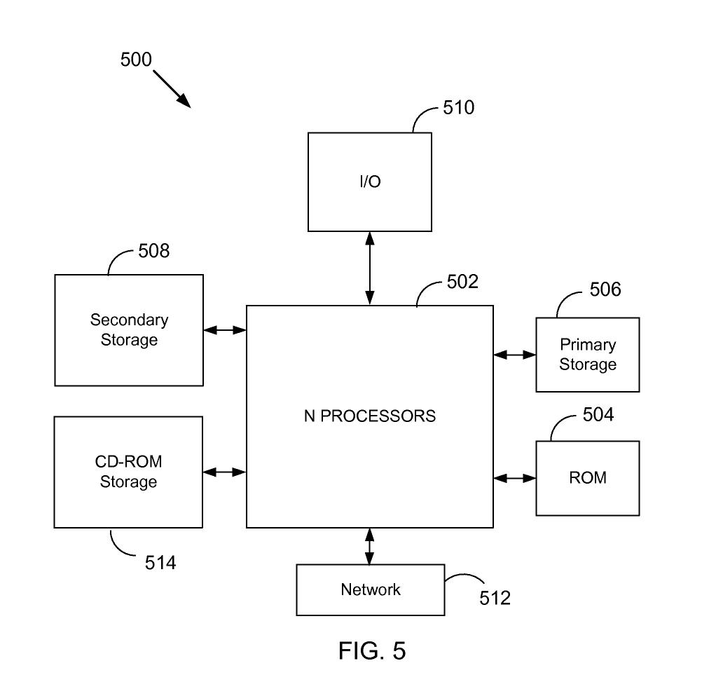

FIG. 5 illustrates a typical computer system that, when appropriately configured or designed, may serve as a computer system 500 for which the present invention may be embodied.

Computer system 500 includes a quantity of processors 502 (also referred to as central processing units, or CPUs) that may be coupled to storage devices including a primary storage 506 (typically a random access memory, or RAM), a primary storage 504 (typically a read-only memory, or ROM). CPU 502 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 504 acts to transfer data and instructions uni-directionally to the CPU and primary storage 506 typically may be used to transfer data and instructions in a bi-directional manner. The primary storage devices discussed previously may include any suitable computer-readable media such as those described above. A mass storage device 508 may also be coupled bi-directionally to CPU 502 and provides additional data storage capacity and may include any of the computer-readable media described above. Mass storage device 508 may be used to store programs, data and the like and typically may be used as a secondary storage medium such as a hard disk. It will be appreciated that the information retained within mass storage device 508, may, in appropriate cases, be incorporated in standard fashion as part of primary storage 506 as virtual memory. A specific mass storage device such as a CD-ROM 514 may also pass data uni-directionally to the CPU.

CPU 502 may also be coupled to an interface 510 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 502 optionally may be coupled to an external device such as a database or a computer or telecommunications or internet network using an external connection shown generally as a network 512, which may be implemented as a hardwired or wireless communications link using suitable conventional technologies. With such a connection, the CPU might receive information from the network, or might output information to the network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: servers and global communication network.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of transaction system according to the present invention will be apparent to those skilled in the art. The invention has been described above by way of illustration, and the specific embodiments disclosed are not intended to limit the invention to the particular forms disclosed. For example, the particular implementation of the computing devices may vary depending upon the particular type computing device used. The computing devices described in the foregoing were directed to laptop computing device implementations; however, similar techniques using mobile computing device implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims. What is claimed is:

1. One or more computer storage media storing computer-usable instructions, that when used by one or more computing devices, cause the one or more computing devices to perform a method comprising the steps of:
communicating a seller's registration information and the seller's item information to a transaction unit, the transaction unit registering an account for the seller, the seller's account at least comprising a seller's dashboard portion being operable for at least displaying transaction offerings for the seller, the seller's item information comprising at least a description of the item without a price for the item, the transaction unit posting the seller's item information to be viewable by all users of the transaction unit;
communicating a buyer's registration information and the buyer's purchase offer for the seller's item to the transaction unit, the transaction unit registering an account for the buyer, the buyer's account at least comprising a buyer's dashboard portion being operable for at least displaying transaction offerings for the buyer, the buyer's purchase offer at least comprising an offer price and a description of an expected item to be delivered for the offer price, the transaction unit posting the buyer's purchase offer to the seller's dashboard portion and notifying the seller of the posting;
displaying at least the seller's dashboard portion to the seller; and
communicating the seller's response for the buyer's purchase offer to the transaction unit, the seller's response at least comprising an acceptable price and a description of the item to be provided at the acceptable price, the transaction unit posting the seller's response to the buyer's dashboard portion and notifying the buyer of the posting.

2. The method as recited in claim 1, further comprising displaying at least the buyer's dashboard portion containing the seller's response to the buyer.

3. The method as recited in claim 2, further comprising communicating the buyer's decision on an acceptance of the seller's response to the transaction unit, the transaction unit posting the buyer's decision to the seller's dashboard portion and notifying the seller of the posting.

4. The method as recited in claim 3, in which the transaction unit processes an accepted transaction by at least debiting funds from the buyer.

5. The method as recited in claim 4, further comprising communicating a buyer's details for receipt of the item provided by the seller, the transaction unit delivering funds to the seller upon a satisfactory receipt by the buyer and crediting funds to the buyer upon an unsatisfactory receipt by the buyer.

6. The method as recited in claim 1, in which the acceptable price and the description of the item to be provided at the acceptable price is a counter offer to the seller's offer price and description of the expected item to be delivered for the offer price.

7. The method as recited in claim 1, in which the registration information further comprises a method for receiving notifications.

8. The method as recited in claim 7, in which the method for receiving notifications comprises email or text messages.

9. A system comprising:
a client application being configured to be operable for at least communicating a seller's registration information and the seller's item information comprising at least a description of the item without a price for the item, communicating a buyer's registration information and the buyer's purchase offer for the seller's item, the buyer's purchase offer at least comprising an offer price and a description of an expected item to be delivered for the offer price, displaying at least the buyer's purchase offer to the seller, and communicating the seller's response for the buyer's purchase offer, the seller's response at least comprising a counter offer at least comprising an acceptable price and a description of the item to be provided at the acceptable price; and
a transaction unit being configured to be operable for communicating with said client application, said transaction unit being further configured to be operable for registering an account for the seller, the seller's account at least comprising a seller's dashboard portion being operable for at least displaying transaction offerings for the seller, said transaction unit being further configured to be operable for posting the seller's item information to be viewable by all users of said transaction unit, said transaction unit being further configured to be operable for registering an account for the buyer, the buyer's account at least comprising a buyer's dashboard portion being operable for at least displaying transaction offerings for the buyer, said transaction unit being further configured to be operable for posting the buyer's purchase offer to the seller's dashboard portion and notifying the seller of the posting, said transaction unit being further configured to be operable for posting the seller's response to the buyer's dashboard portion and notifying the buyer of the posting.

10. The system as recited in claim 9, in which said client application is further configured to be operable for displaying at least the buyer's dashboard portion containing the seller's response to the buyer, communicating the buyer's decision on an acceptance of the seller's response to the transaction unit, and communicating a buyer's details for receipt of the item provided by the seller, and said transaction unit is further configured to be operable for posting the buyer's decision to the seller's dashboard portion and notifying the seller of the posting, processing an accepted transaction by at least debiting funds from the buyer, delivering funds to the seller upon a satisfactory receipt by the buyer, and crediting funds to the buyer upon an unsatisfactory receipt by the buyer.

11. The method as recited in claim 9, in which the registration information further comprises a method for receiving notifications.

12. The method as recited in claim 9, in which the method for receiving notifications comprises email or text messages.

13. A non-transitory program storage device readable by a machine tangibly embodying a program of instructions executable by the machine to perform a method for transactions, comprising:
computer code for communicating a seller's registration information and the seller's item information to a transaction unit, the transaction unit registering an account for the seller, the seller's account at least comprising a seller's dashboard portion being operable for at least displaying transaction offerings for the seller, the seller's item information comprising at least a description of the item without a price for the item, the transaction unit posting the seller's item information to be viewable by all users of the transaction unit;
computer code for communicating a buyer's registration information and the buyer's purchase offer for the seller's item to the transaction unit, the transaction unit registering an account for the buyer, the buyer's account at least comprising a buyer's dashboard portion being operable for at least displaying transaction offerings for the buyer, the buyer's purchase offer at least comprising an offer price and a description of an expected item to be delivered for the offer price, the transaction unit posting the buyer's purchase offer to the seller's dashboard portion and notifying the seller of the posting;
computer code for displaying at least the seller's dashboard portion to the seller; and
computer code for communicating the seller's response for the buyer's purchase offer to the transaction unit, the seller's response at least comprising an acceptable price and a description of the item to be provided at the acceptable price, the transaction unit posting the seller's response to the buyer's dashboard portion and notifying the buyer of the posting.

14. The non-transitory program storage device as recited in claim 13, further comprising computer code for displaying at least the buyer's dashboard portion containing the seller's response to the buyer.

15. The non-transitory program storage device as recited in claim 14, further comprising computer code for communicating the buyer's decision on an acceptance of the seller's response to the transaction unit, the transaction unit posting the buyer's decision to the seller's dashboard portion and notifying the seller of the posting.

16. The non-transitory program storage device as recited in claim 15, in which the transaction unit processes an accepted transaction by at least debiting funds from the buyer.

17. The non-transitory program storage device as recited in claim 16, further comprising computer code for communicating a buyer's details for receipt of the item provided by the seller, the transaction unit delivering funds to the seller upon a satisfactory receipt by the buyer and crediting funds to the buyer upon an unsatisfactory receipt by the buyer.

18. The non-transitory program storage device as recited in claim 13, in which the acceptable price and the description of the item to be provided at the acceptable price is a counter offer to the seller's offer price and description of the expected item to be delivered for the offer price.

19. The non-transitory program storage device as recited in claim 13, in which the registration information further comprises a method for receiving notifications.

20. The non-transitory program storage device as recited in claim 19, in which the method for receiving notifications comprises email or text messages.
